(19) United States
(12) Patent Application Publication
(10) Pub. No.: US 2020/0387838 A1
(43) Pub. Date: Dec. 10, 2020

(54) DATABASE MANAGEMENT AND SYSTEM INTEGRATION FOR EVENT BOOTH MAPPING

(71) Applicant: MIRROR SHOW MANAGEMENT, Webster, NY (US)

(72) Inventor: Peter Stam, Rochester, NY (US)

(21) Appl. No.: 16/435,076

(22) Filed: Jun. 7, 2019

(51) Int. Cl. G06Q 10/02; G06F 16/29; G06F 16/9537; G06F 16/9538

(52) U.S. Cl. CPC G06Q 10/02; G06F 16/9538; G06F 16/9537; G06F 16/29

(57) ABSTRACT

Systems and methods providing dynamically customized mapping of event spaces by generating user-specific maps of booth spaces within event spaces are disclosed. Three-dimensional user-specific maps are generated based upon a match between user attributes of a user and booth types of booth spaces, as well as real-time availability data for such booth spaces based upon previous reservations by other users. An event map management system maintains an event database to store layout data, booth space data, and availability data for a plurality of booth spaces. The event map management system also communicates with an event registration system to obtain information regarding registered users and reserve booth spaces for users.

### TECHNICAL FIELD

The present disclosure generally relates to systems and methods for generating user-specific maps of event booth spaces within event spaces, as well as maintaining current status data while facilitating reservation of booth spaces by registered users.

### BACKGROUND

Trade shows, conferences, and similar events typically include large event spaces dedicated to booths for exhibitors to showcase their products or services. In order to have a booth at an event, the exhibitors must typically register with the event organizer and reserve a booth space within the event space. The event organizer establishes the layout of the event space, including the locations of a plurality of booth spaces. The booth spaces often vary in both size and desirability, so reservation of larger or more desirable booths may be limited to higher-level sponsors of an event or may be associated with a higher rental fee. Thus, the booth spaces are commonly divided into a number of booth types. While electronic event registration systems exist to maintain exhibitor registration records and booth space reservation records, such systems do not facilitate useful comparison of booth spaces available to specific exhibitors. Such systems also do not provide useful interfaces for exhibitors to obtain relevant booth space data (e.g., booth spaces available for reservation by the exhibitor) together with contextual information regarding other booth spaces or additional aspects of the event space.

### SUMMARY

The present application discloses a method, system, and computer-readable medium storing instructions for providing dynamically customized mapping of event spaces. Such techniques overcome the limitations of existing event registration systems and event mapping systems. The method, system, or instructions may include receiving a request from a user to generate a user-specific map of an event space; determining one or more user attributes associated with the user, the one or more user attributes including a user booth type associated with the user from a plurality of booth types; accessing event data associated with a plurality of booth spaces in the event space from an event database, the event data including (i) layout data regarding positions of the plurality of booth spaces within the event space and (ii) booth space data indicating a booth type of each booth space of the plurality of booth spaces from the plurality of booth types; identifying one or more user-filtered booth spaces from the plurality of booth spaces based upon a match between the user booth type and the booth type of the respective user-filtered booth space; generating a user-specific map of the event space using the layout data, the user-specific map indicating positions of each of the plurality of booth spaces and indicating the one or more user-filtered booth spaces by a visually distinguishing characteristic applied to each of the one or more user-filtered booth spaces; and/or causing the user-specific map to be presented to the user via a display of a user computing device. The user-specific map may be a three-dimensional map representing the event space in three dimensions. Visually distinguishing characteristic may include one or more of the following: color, shading, or transparency.

In some embodiments, the event data may further include availability data indicating availability of each booth space of the plurality of booth spaces. In such embodiments, the one or more user-filtered booth spaces may be identified by determining the one or more user-filtered booth spaces are available to be reserved by the user based upon the availability data, such that the one or more user-filtered booth spaces are one or more user-available booth spaces. In some such embodiments, the techniques may further include receiving a selection of a user-selected booth space from the one or more user-available booth spaces, reserving the user-selected booth space by associating the user-selected booth space with the user, and/or updating the availability data to indicate the user-selected booth space as unavailable. Reserving the user-selected booth space may include sending a reservation message indicating reservation of the user-selected booth space by the user to an event registration system via a communication network. Updating the availability data may include updating an entry in the event database in real time upon receiving the selection of the user-selected booth space.

In further embodiments, the one or more user attributes may be determined by communication with an event registration system via a communication network. Such communication may include sending a user status request message including a user identifier uniquely identifying the user to the event registration system, receiving user registration data associated with the user from the event registration system, and determining the one or more user attributes based upon the user registration data. The user registration data may include a registration level of the user.

In still further embodiments, the layout data may include information regarding additional aspects of the event space, such as walkways, power outlets, lighting, setback requirements, or height restrictions. In some such embodiments, the techniques may further include receiving an indication of additional filter criteria associated with the additional aspects of the event space to apply to the plurality of booth spaces, identifying one or more additionally filtered booth spaces from the one or more user-filtered booth spaces based upon the additional filter criteria, generating an additionally filtered map of the event space using the layout data, and/or causing the additionally filtered map to be presented to the user via the display of the user computing device. The additionally filtered map may indicate the one or more additionally filtered booth spaces by additional visually distinguishing characteristic applied to each of the one or more additionally filtered booth spaces.

In various embodiments, additional, fewer, or alternate actions may be included or performed by the method, system, and computer-readable medium, including those discussed elsewhere herein.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates a block diagram of an exemplary data system on which the methods described herein may operate in accordance with the embodiments described herein;

FIG. 2 illustrates a block diagram of an exemplary computing device in accordance with the embodiments described herein;

FIG. 3 illustrates a flow diagram of an exemplary event data definition method for generating the event data for an event space;

FIG. 4 illustrates an exemplary event space map showing the layout of booth spaces and other aspects of the event space;

FIG. 5 illustrates a flow diagram of an exemplary customized map generation method 500 for generating and presenting a user-specific map;

FIG. 6 illustrates an exemplary user-specific map of the event space;

FIG. 7 illustrates a flow diagram of an exemplary booth space reservation method for reserving an available booth space within an event space; and

FIG. 8 illustrates a sequence diagram of an exemplary user-specific booth space identification and reservation communication sequence.

### DETAILED DESCRIPTION

The invention described herein is related to methods and systems for generating user-specific maps of event spaces having a plurality of booth spaces, as well as to reservation of booth spaces by users of such systems. Specifically, the disclosure involves an event map management system that interfaces with both user devices and event registration systems to maintain an event database regarding the layout of the event space. The event database further maintains information regarding each of the plurality of booth spaces in order to facilitate user-specific map generation by matching booth space data with user attributes. In some embodiments, the event database also includes availability data indicating whether each booth space is available or unavailable (e.g., already reserved). Such availability data may be updated in real time as users reserve booth spaces. Thus, the systems and methods may be used to generate accurate and current maps of event spaces that indicate user-available booth spaces that may be reserved by a particular user at a particular time. Such user-specific maps may be generated and presented using three-dimensional representations of booth spaces and event spaces in order to provide accurate information to users for planning and decision-making purposes. Thus, the methods and systems described herein offer improved accuracy and reliability over existing event management systems, which lack such features.

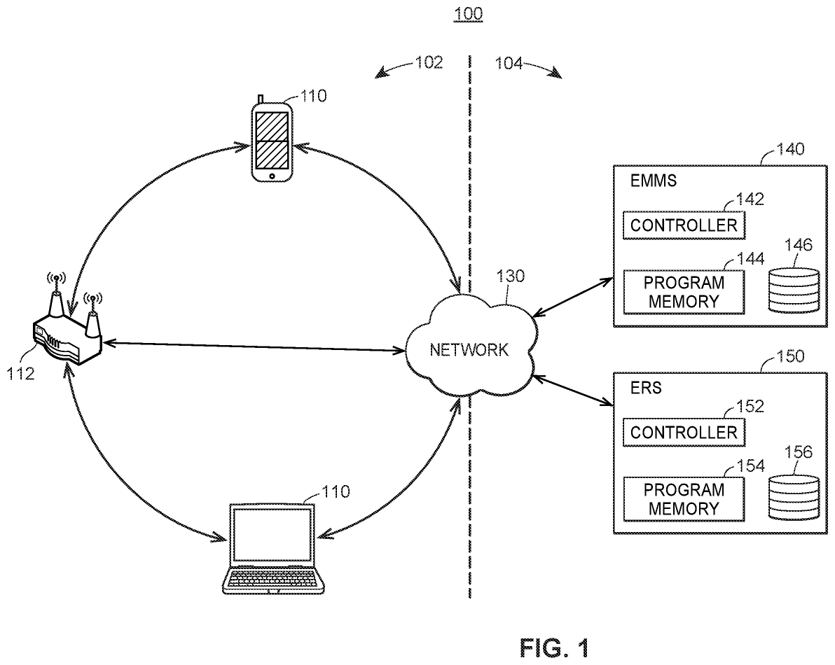

FIG. 1 illustrates a block diagram of an exemplary data system 100 for implementing the techniques disclosed herein. The high-level architecture includes both hardware and software components, as well as various data communications channels for communicating data between the various hardware and software components. The data system 100 may be roughly divided into front-end components 102 and back-end components 104 communicatively connected via a communication network 130. In exemplary embodiments described in detail herein, the front-end components 102 and back-end components 104 may be used to facilitate generation of user-specific maps of event spaces by the back-end components 104 and presentation of such user-specific maps by the front-end components 102. In further embodiments, users of the front-end components 102 may register or reserve booth spaces within an event space by communication with the back-end components 104, which maintain and process data relating to the event space, user registration, and booth space reservations.

The front-end components 102 may communicate via the communication network 130 with the back-end components 104, as well as with other front-end components 102. For example, the front-end components 102 may include one or more user computing devices 110 communicatively connected to the back-end components 104 via the communication network 130. As illustrated, the computing systems may include one or more user computing devices 110 associated with a user (e.g., a smartphone, a desktop computer, notebook, or tablet computer of an exhibitor, organizer, or administrator). Each user computing device 110 may be operated by a user to input, request, obtain, and present data using one or more software programs, which data may include information regarding booth spaces within an event space. In some embodiments, the user computing devices 110 communicate with one or more routers 112 to exchange data with each other or with the back-end components 104. It should be understood that the data system 100 may include any number of each of the front-end components 102, as well as additional components in some embodiments. Any of the front-end components 102 may be directly or indirectly connected to the communication network 130.

The front-end components 102 may be arranged in various configurations including varying components. In some embodiments, the front-end components 102 may include a plurality of user computing devices 110 configured to access information from and communicate information to the back-end components 104 via the communication network 130. Each of the user computing devices 110 may send and receive data associated with the user or the event space by executing general-purpose or special-purpose software application running on the devices, such as from a web browser or an event data application. The user computing devices 110 may obtain data regarding the event space (e.g., layout data or booth availability) via the communication network 130 from the back-end components 104, as discussed further below. In some embodiments, the user computing devices 110 may further communicate with the back-end components 104 to register for events or reserve booth spaces within event spaces.

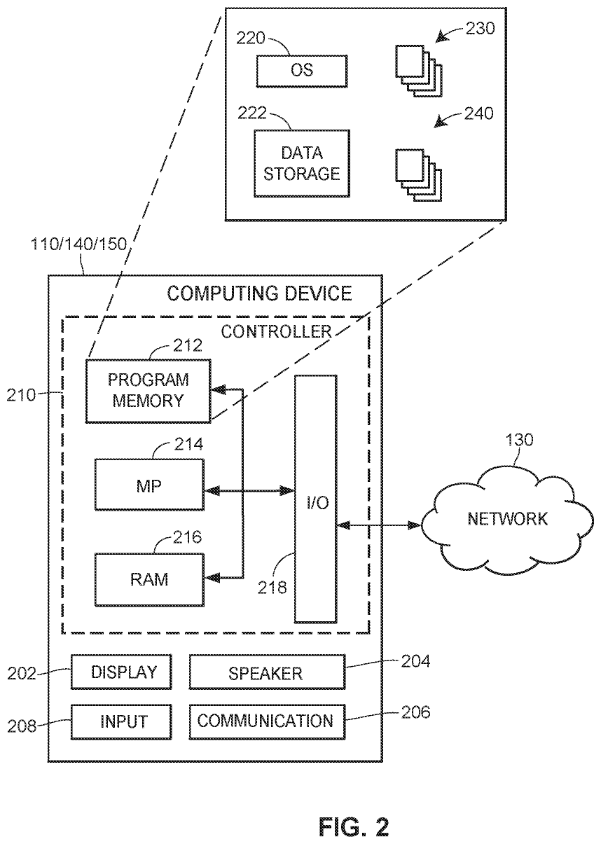

In various embodiments, the user computing devices 110 may be any known or later-developed dedicated-use or general-use mobile personal computers, smartphones, tablet computers, or wearable computing devices (e.g., watches, glasses, etc.). For example, the user computing device 110 may be a general use desktop or tablet computer with a web browser. In some embodiments, the user computing device 110 may be a thin client device, wherein much or all of the computing processes are performed by servers of the back-end components 104, with information communicated between the thin client device and such servers via the communication network 130. The user computing device 110 may include any number of internal components and may be further communicatively connected to one or more external components by any known wired or wireless means (e.g., USB cables, Bluetooth communication, etc.). An embodiment of the user computing device 110 is further discussed below with respect to FIG. 2.

One or more routers 112 may be included within the data system 100 to facilitate communication. The routers 112 may be any wired, wireless, or combination wired/wireless routers using any known or here-after developed communication protocol for general- or special-purpose computer communication. In some embodiments, the user computing devices 110 may be communicatively connected to the communication network 130 via one or more routers 112. Wireless communication may occur by any known means, such as Bluetooth, Wi-Fi, or other appropriate radio-frequency or other communications protocols.

The front-end components 102 communicate with the back-end components 104 via the communication network 130. The communication network 130 may be a proprietary network, a secure public internet, a virtual private network or some other type of network, such as dedicated access lines, plain ordinary telephone lines, satellite links, cellular data networks, combinations of these, etc. Where the communication network 130 comprises the Internet, data communications may take place over the communication network 130 via an Internet communication protocol.

The back-end components 104 may communicate via the communication network 130 with the front-end components 102, as well as with other back-end components 104, to communicate, process, generate, and store data. To this end, the back-end components 104 may include an event map management system 140 (EMMS) and an event registration system 150 (ERS) that store data received from the front-end components 102 via the communication network 130 and provide requested data to the front-end components 102. Each of the event map management system 140 and event registration system 150 may be implemented as servers configured to execute software applications to facilitate event registration, mapping, reservations, or management. In some embodiments, the back-end components 104 may each include a plurality of servers performing distinct or overlapping functions. It should be understood that the data system 100 may include any number of each of the back-end components 104, as well as additional components in some embodiments. Any of the back-end components 104 may be directly or indirectly connected to the communication network 130 for communication with the front-end components 102, with other back-end components 104, and with other networked components (e.g., third-party information systems).

Each of the event map management system 140 and event registration system 150 may be controlled by one or more processors of a controller to execute software instructions stored in non-transitory program memories, which may include or be communicatively connected to one or more databases associated with events. Thus, the event map management system 140 includes a controller 142, a program memory 144, and an event database 146. The event registration system 150 likewise includes a controller 152, a program memory 154, and a registration database 156. Each of the controllers 142 and 152 may include one or more computer processors adapted and configured to execute various software applications and routines of the data system 100 stored in the respective program memories 144 and 154, in addition to other software applications.

The program memory 144 may include an event map management application for managing event data relating to an event space, such as layout data regarding booth spaces and additional aspects of the event space, booth space data regarding attributes of each of the booth spaces within the event space, and availability data indicating the availability (e.g., reservation status) of each of the booth spaces within the event space. Such event data may be stored in the event database 146. Similarly, the program memory 154 may include an event registration application for managing user registration data and other data relating to an event, such as a trade show, exhibition, or conference. The user registration data may be stored in the registration database 156 and may include a user account type or user booth type indicating one or more types of booth spaces the user is eligible to reserve based upon a user level. The databases 146 and 156 may be accessed by the respective controllers 142 and 152 to obtain or store data when executing various functions and tasks associated with the data system 100. Although referred to herein as a single database 146 or 156, each of the event database 146 or the registration database 156 may be implemented as multiple databases in some embodiments, which may be relational or non-relational.

FIG. 2 illustrates a block diagram of an exemplary user computing device 110, event map management system 140, or event registration system 150 in accordance with the data system 100. Any such user computing device 110, event map management system 140, or event registration system 150 may, in some embodiments, include additional, alternative, or fewer components than the exemplary computing device illustrated in FIG. 2. Although the following description refers to the user computing device 110 for simplicity and clarity, it should be understood that any combination of features described herein with respect to the user computing device 110 may be included in the event map management system 140 or in the event registration system 150.

The user computing device 110 may be a desktop computer, a notebook computer, a netbook computer, a smartphone, a tablet computer, or similar mobile or stationary computing device capable of receiving and processing electronic information. In some embodiments, the user computing device 110 may be a client computing device for a local server associated with the user. Similarly, in some embodiments, the event map management system 140 or the event registration system 150 may include servers configured to receive, store, process, and communicate data with other computing devices. In such embodiments, the servers may lack user input/output components, instead being connected to other computing devices via the communication network 130 via a communication unit 206.

The user computing device 110 may communicate with the event map management system 140 or the event registration system 150 via the communication network 130 to send and receive data, as discussed elsewhere herein. The data may be processed by the controller 210 to perform various operations for the user. When the controller 210 (or other processor) receives an indication of a user action or request, appropriate responses are determined and implemented. Such responses may include processing data for presentation to the user, requesting data from other computing devices, processing data from other front-end components 102 or back-end components 104, determining information regarding the user computing device 110, sending data to other computing devices, or presenting information to the user via a display 202 or speaker 204. In some embodiments, the user computing device 110 may include a communication unit 206 to send and receive information from local or remote computing devices (e.g., the event map management system 140 or the event registration system 150), either directly or through the communication network 130. The communication unit 206 may include a wireless communication transceiver, such as a Wi-Fi or Bluetooth communication component. Further embodiments of the user computing device 110 may include one or more inputs 208 to receive instructions, selections, or other information from a user of the user computing device 110.

The user computing device 110 may include various input and output components, units, or devices. The display 202 and speaker 204, along with other integrated or communicatively connected output devices (not shown), may be used to present information to the user of the user computing device 110 or others. The display 202 may include any known or hereafter developed visual or tactile display technology, including LCD, OLED, AMOLED, projection displays, refreshable braille displays, haptic displays, or other types of displays. The one or more speakers 204 may similarly include any controllable audible output device or component, which may include a haptic component or device. In some embodiments, communicatively connected speakers 204 may be used (e.g., headphones, Bluetooth headsets, docking stations with additional speakers, etc.). The input 208 may further receive information from the user. Such input 208 may include a physical or virtual keyboard, a microphone, virtual or physical buttons or dials, or other means of receiving information. In some embodiments, the display 202 may include a touch screen or otherwise be configured to receive input from a user, in which case the display 202 and the input 208 may be combined.

The user computing device 110 may also communicate with the router 112 or the communication network 130 using the communication unit 206, which may manage communication between the controller 210 and external devices. The communication unit 206 may transmit and receive wired or wireless communications with external devices, using any suitable wireless communication protocol network, such as a wireless telephony network (e.g., GSM, CDMA, LTE, etc.), a Wi-Fi network (802.11 standards), a WiMAX network, a Bluetooth network, etc. Additionally, or alternatively, the communication unit 206 may also be capable of communicating using a near field communication standard (e.g., ISO/IEC 18092, standards provided by the NFC Forum, etc.). Furthermore, the communication unit 206 may provide input signals to the controller 210 via the I/O circuit 218. The communication unit 206 may also transmit user input, device status information, control signals, or other output from the controller 210 to other computing devices (e.g., the event map management system 140 or the event registration system 150) via the communication network 130.

The user computing device 110 may further include a controller 210. The controller 210 may be configured to receive, process, produce, transmit, and store data. The controller 210 may include a program memory 212, one or more processors or microprocessors (MP) 214, a random access memory (RAM) 216, and an I/O circuit 218. The components of the controller 210 may be interconnected via an address/data bus or other means. It should be appreciated that although FIG. 2 depicts only one microprocessor 214, the controller 210 may include multiple microprocessors 214 in some embodiments. Similarly, the memory of the controller 210 may include multiple RAM 216 or multiple program memories 212. Although the FIG. 2 depicts the I/O circuit 218 as a single block, the I/O circuit 218 may include a number of different I/O circuits, which may be configured for specific I/O operations. The microprocessor 214 may include one or more processors of any known or hereafter developed type, including general purpose processors or special-purpose processors. Similarly, the controller 210 may implement the RAM 216 and program memories 212 as semiconductor memories, magnetically readable memories, optically readable memories, or any other type of memory.

The program memory 212 may include an operating system 220, a data storage 222, a plurality of software applications 230, and a plurality of software routines 240. The operating system 220, for example, may include one of a plurality of platforms such as the Windows®, Linux®, Unix®, iOS®, or Android™ systems. The data storage 222 may include data such as user profiles and preferences, application data for the plurality of applications 230, routine data for the plurality of routines 240, or other data related to implementation of part or all of the methods described elsewhere herein. In some embodiments, the controller 210 may also include, or otherwise be communicatively connected to, other data storage mechanisms (e.g., one or more hard disk drives, optical storage drives, solid state storage devices, etc.) that reside within the user computing device 110. Moreover, in thin-client implementations, additional processing and data storage may be provided by external devices, either locally or via the communication network 130.

The software applications 230 and routines 240 may include computer-readable instructions that cause the processor 214 to implement data processing and communication functions. Thus, the software applications 230 may include one or more applications corresponding to various parts of the techniques disclosed herein. The software routines 240 may support the software applications 230 and may include routines such as communication routines for communicating via the communication network 130 or display routines for generating or presenting data representations to the user via the display 202.

The data system 100 described above and illustrated in FIGS. 1-2 may be used to perform the various methods discussed further below. Together, the methods described below relate to providing information regarding event spaces to users of electronic information systems, including maps and other information regarding booth spaces within such event spaces. As described further below, users of user computing devices 110 may obtain user-specific maps of event spaces, which may indicate available booth spaces that may be reserved by the user. In some embodiments, users may select and reserve available booth spaces, in response to which the status of such booth spaces may be updated in the event database 146, the registration database 156, or both.

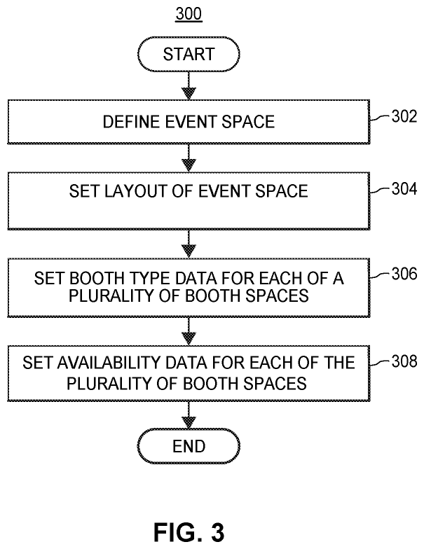

FIG. 3 illustrates a flow diagram of an exemplary event data definition method 300 for initial generation of the event data associated with an event or an event space. The event data definition method 300 may be implemented by an operator interacting with the event map management system 140 to populate the event database 146 with event data for use in map generation and reservation, as discussed further below. The event data indicates the layout of the event space associated with an event, including data relating to the layout and aspects of a plurality of booth spaces within the event space. Thus, the event data may include one or more of the following: (i) layout data regarding positions of the booth spaces within the event space, as well as other aspects of the event space (e.g., walkways, entryways, stages, or boundaries of the event space); (ii) booth space data regarding aspects of each booth space in the event space, including booth types of the booth spaces; and (iii) availability data indicating the availability of each booth space within the event space. Such event data may be specified by the operator based upon physical constraints of the event space, relevant rules and regulations for event space layout, layout decisions for the event space by the event organizer, and booth cost or reservation decisions for the event by the event organizer. In some embodiments, multiple operators may each perform portions of the event data definition method 300.

The event data definition method 300 may begin with a definition of the event space (block 302). The event space is preferably defined in three dimensions to facilitate improved mapping. In some embodiments, defining the event space may include the operator specifying the boundaries and other salient features of the event space, such as doorways, lights, power connections, ceiling height, windows, or other similarly fixed aspects of the space. The operator may generate a model of the event space using the event map management system 140 or another system (e.g., a computer aided drafting program). Alternatively, the operator may select a previously specified model of the event space in order to define the event space. If a portion of the physical location where the event is to be held will not be usable during the event, the event space may be modified to define only the usable portion of the event space. Data defining the event space may then be stored in the event database 146 for further use in layout and mapping. In some embodiments, an event may include multiple distinct event spaces, such as multiple rooms, floors, or buildings. In such embodiments, the event database 146 may store the event spaces separately or together.

Once the event space is defined, the operator may set the layout of the event space (block 304). The layout data includes both booth space elements for a plurality of booth spaces. Each booth space is defined by an element (e.g., an object or a database entry) within the event data, such that the element specifies the location, dimensions, and orientation of the booth space. As with the event space definition, it is preferable that the booth spaces be defined as having volume in three dimensional space to improve the usefulness of maps generated from such event data. For example, defining booth spaces as three-dimensional elements having volume within a three-dimensional event space may allow exhibitors to confirm booth height limitations when reserving a booth space, thereby avoiding additional costs or logistical problems. The operator may interact with an interface of a computing device (e.g., a user computing device 110) communicatively connected to the event map management system 140 to place and shape booth spaces within the defined event space. In addition to booth spaces, other aspects of the event space may be defined by the operator as elements within the event space, such as walkway elements. Thus, the layout data may further include information regarding additional aspects of the event space, including one of more of the following: walkways, power outlets, lighting, setback requirements, or height restrictions. Such additional aspect elements may likewise be defined as three-dimensional elements within the event space.

In addition to setting the layout of the booth spaces, the operator may further set booth types for each booth space (block 306). The booth type may be selected for each booth space from a predefined set of a plurality of booth types. For example, the event organizer may specify a certain number of booth types, which may correspond with exhibitor levels such that exhibitors may only select booth spaces matching their levels. In some embodiments, booth types may be set when each booth space is created and placed within the event space. In further embodiments, the event map management system 140 may automatically determine a booth type of each booth space based upon a decision logic, which may include one or more of the following variables: size of the booth space (either in terms of volume or floor space), area of the event space, access to walkways, or proximity to entrances.

Availability data may also be set for each of the plurality of booth spaces (block 308), which may include entering a parameter value indicating availability for each of the booth spaces in the event database 146. In some embodiment, the availability data may include values indicating the booth space is available or indicating the booth space is reserved/unavailable. In further embodiments, the availability data may include an additional value indicating a pending reservation request has been entered for a booth space but has not yet been confirmed.

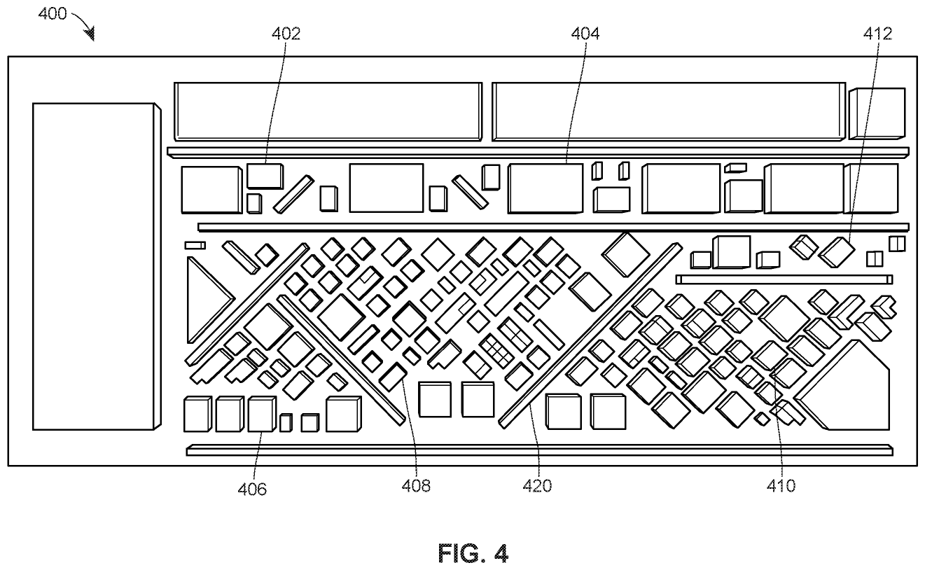

FIG. 4 illustrates an exemplary event space map 400, showing the layout of booth spaces and other aspects of the event space. The event space map 400 is not filtered by any aspects of the event space or attributes of a user. Such event space map 400 may be generated and used by event organizers, system administrators, event visitors, or others seeking a complete map of the event space layout. As illustrated, the event space map 400 may be generated as a three-dimensional map indicating a height dimension of each booth space or other relevant aspects. This three-dimensional view is advantageous for certain tasks, such as ensuring adequate space for booth construction and complying with height restriction, which may vary by location even within an event space. In other embodiments, however, two-dimensional views may be advantageous, such as for navigation of the event space by visitors. 7

It should be noted that the event space map 400 includes a plurality of booth spaces of different dimensions. For example, booth spaces 402, 404, 406, 408, 410, and 412 include booth spaces of different dimensions in different areas of the event space. Each booth space is represented in the event data stored in the event database 146 by information defining at least a position of the booth space (e.g., location, dimensions, and orientation within the event space) and a booth type (e.g., a cost or a sponsorship level) associated with the booth space. Additional aspects or attributes of booth spaces may also be included in the event data or separately stored for each booth space (e.g., booth space availability data) in some embodiments, as discussed further below. Booth type or other aspects of booth spaces may be visually indicated in the event space map 400, such as by displaying different types of booths with different colors or different patterns. In addition to booth spaces, walkways 420 are also included in the event space map 400 in order to readily identify booth space access to visitor traffic. In further embodiments, other aspects of the event space may be indicated in the event space map 400, such as power outlets, lighting, stairways, elevators, restrooms, windows, or relevant features located within the event space.

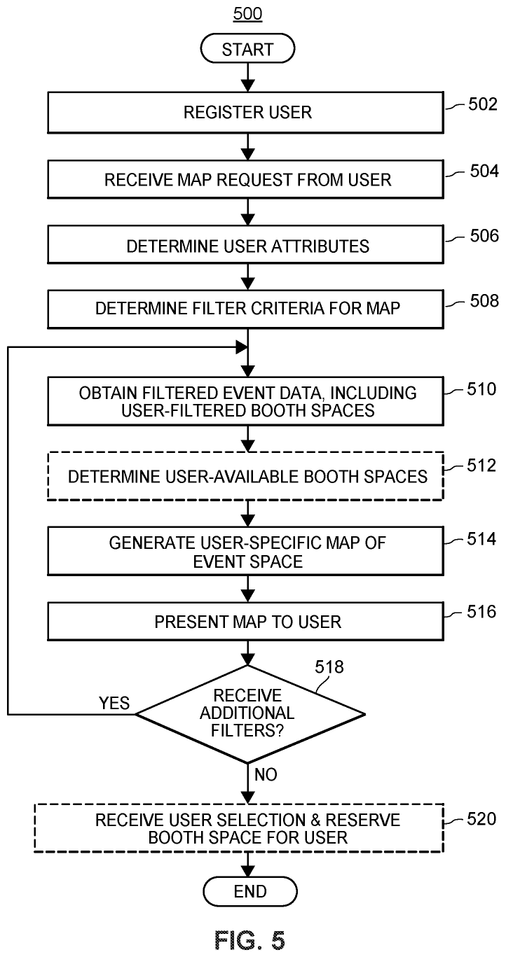

FIG. 5 illustrates a flow diagram of an exemplary customized map generation method 500 for generating and presenting a user-specific map for a registered user, such as an exhibitor or an event organizer. The customized map generation method 500 may be implemented by the event map management system 140 in communication with the user computing device 110 and, in some embodiments, with the event registration system 150. After the event data representing the layout of an event space and various booth spaces in the event space, as discussed above, the event map management system 140 may provide customized maps or map data to be presented to a user via the user computing device 110. Such user-specific maps may visually indicate allowable or available booth spaces based upon user attributes (e.g., user sponsorship level) or existing reservations, thereby allowing a user to easily identify potential booth spaces to reserve. In some embodiments, the customized map generation method 500 may further include booth space reservation, as discussed further below.

The customized map generation method 500 may begin, in some embodiments, with registering a user for customization of the user experience (block 502). In other embodiments, the method 500 may begin with receiving a map request from the user (block 504), in response to which the relevant user attributes of the user are determined (block 506) and used to determine filter criteria for use in generating a user-specific map (block 508). Once the filter criteria are determined, filtered event data is obtained from the event database 146 (block 510) to identify user-filtered booth spaces. In some embodiments, availability data may be accessed and used to determine user-available booth spaces (block 512), which are booth spaces matching the filter criteria that are also available for reservation. A user-specific map of the event space is then generated to show the user-filtered booth spaces or user-available booth spaces (block 514) and presented to the user via the user computing device 110 (block 516). If additional filters are received from the user (block 518), such filters may be used to generate and present an additional user-specific map (blocks 510-516). In some embodiments, a user may selected and reserve a booth space from the user-specific map (line 820).

At block 502, in some embodiments, the event map management system 140 may register the user of the user computing device 110. The user may be registered as a class of user associated with various permissions and features, such as an exhibitor, an administrator, or a visitor. Such registration may include communication with the event registration system 150 to perform initial registration of the user for an event or to authenticate the user as a registered user of the event registration system 150. Thus, the event map management system 140 may rely upon the event registration system 150 to handle user registration, allowing the user to log in to the event map management system 140 based upon the user's existing registration for an event with the event registration system 150. In some embodiments, users may opt not to register, in which case a general map may be generated or the user may input relevant data to facilitate user-specific map generation.

At block 504, the event map management system 140 receives a map request from the user requesting the generation of a user-specific map of an event space. The map request may be generated by the user computing device 110 based upon user interaction with a user interface, which may be implemented as a web site interface or a web browser application interface. In some embodiments, the map request may specify the user or an event space for the user-specific map. In other embodiments, the user and event space may be automatically determined by the event map management system 140 based upon context, such as user registration or data associated with a user account. In some embodiments, the user may access the event map management system 140 through a web browser application (e.g., a JavaScript application) accessed through a web site, in which case the web site URL may indicate the relevant event space.

At block 506, the event map management system 140 determines one or more user attributes associated with the user making the map request. The user attributes may include a user type or a user booth type indicating one or more types of booth spaces the user may reserve. For example, a user may be registered for an event (through the event registration system 150) at a sponsorship level authorizing the user to reserve a certain number of a certain type of booth spaces for the event. Typically, higher sponsorship levels are associated with larger or better positioned booth spaces within the event space. In some embodiments, some users may be allotted more than one booth space, so the user attributes for such users may include a number of booth spaces allotted to the user. The user attributes may thus include one or more booth types for the user, which may be selected from a predefined set of a plurality of booth types for the booth spaces within the event space.

Because the user attributes may be associated with the user through a user account with the event registration system 150 (e.g., through user registration data stored in the registration database 156), in some embodiments, the user attributes may be determined from user registration data received from the event registration system 150 via the communication network 130. To obtain such user registration data, the event map management system 140 may send a user status request message identifying the user to the event registration system 150. Such request may include a user identifier (user ID) to uniquely identify the user and, in some embodiments, may include user credentials to authenticate the user. Such request may utilize public APIs of the event registration system 150 to obtain such user registration data. In response to receiving the user status request message, the event registration system 150 may retrieve the requested data from the registration database 156 based upon the user ID and send a return message containing such user registration data to the event map management system 140. The return message includes user registration data that directly or indirectly indicates at least a booth type associated with the user, which may be indirectly indicated by including a registration level of the user that is associated with at least one booth type. Upon receiving the return message, the event map management system 140 may determine the user attributes based upon the user registration data.

At block 508, the event map management system 140 determines filter criteria for the user-specific map based upon the user attributes. The filter criteria may include indications of the variables used to filter the event data in the event database 146, such as an indication of the event or event space and an indication of the booth type of the user. The indication of the event or the event space may be used to identify the specific event space of the specific event in embodiments in which the event database 146 contains data for a plurality of events and event spaces. In embodiments in which the event database 146 stores data regarding only one event space for one event, such indication of the event or event space may be unnecessary. The filter criteria include at least one or more booth types in order to identify event data relating to booth spaces having booth types matching the booth type or types associated with the user. In some embodiments, the filter criteria may further include availability status of the booth spaces in order to further limit the filtered event data to only those booth spaces that are available to be reserved by the user (e.g., to exclude booth spaces that are already reserved), as discussed further below.

At block 510, the event map management system 140 obtains filtered event data for the user-specific map based upon the filter criteria. Thus, the event map management system 140 obtains event data associated with booth spaces matching the user attributes, particularly the booth type associated with the user. Such matching booth spaces are thus identified as user-filtered booth spaces based upon the booth space data matching the user attributes indicated by the filter criteria. In some embodiments, such matching based upon the filter criteria may include only booth type. In alternative embodiments, the matching based upon filter criteria may include booth type and availability. Still further embodiments may include additional, alternative, or fewer filter criteria. The filtered event data may be obtained by accessing the event database 146, such as through a database management application, to query the event database 146 using the filter criteria. The filtered event data may include layout data and booth space data for one or more booth spaces meeting the filter criteria (e.g., booth type). The filtered event data may also include layout data not associated with any particular booth spaces, such as layout data describing the event space or non-booth aspects of the event space (e.g., event space boundaries and walkways). In some embodiments, the filtered event data may include data regarding the layout of booth spaces not matching the filter criteria, in which embodiments either the matching or the non-matching booth spaces may be identified for distinct presentation in the user-specific map.

At block 512, in some embodiments, the event map management system 140 may determine user-available booth spaces from among the user-filtered booth spaces. The user-available booth spaces may be determined based upon availability data indicating the availability of each of the plurality of booth spaces in the event space, which availability data may be stored in the event database 146. The booth spaces may thus be filtered based upon the availability data to identify user-available booth spaces that are both user-filtered booth spaces that are also available for selection and reservation. In some embodiments, such filtering based upon availability data may be combined with the filtering based upon the filter criteria discussed above at block 510.

At block 514, the event map management system 140 may generate a user-specific map of the event space based upon the filtered event data to indicate the user-filtered booth spaces or the user-available booth spaces. The user-specific map may be a three-dimensional map representing the event space in three dimensions, showing the positions (i.e., location, dimensions, and orientation) of the relevant booth spaces as three-dimensional elements within the event space. The user-specific map may be generated based upon the layout data regarding the event space and the relevant booth spaces (e.g., the user-filtered booth spaces or the user-available booth spaces). In some embodiments, both the user-filtered booth spaces matching the filter criteria (or the user-available booth spaces) and other booth spaces not matching the filter criteria (or booth spaces indicated as being unavailable by the availability data) may be included in the user-specific map, but the user-filtered booth spaces (or the user-available booth spaces) may be visually distinguished to identify such booth spaces to the user. Thus, a visually distinguishing characteristic may be applied to the user-filtered booth spaces (or the user-available booth spaces) within the map. Such visually distinguishing characteristics may include an adjustment to a color, shading, pattern, or transparency of the relevant booth spaces. In some embodiments, generating the user-specific map may include generating user-specific map data representing the event space, which user-specific map data may be sent to the user computing device 110 in order to render the user-specific map. For example, the event map management system 140 may generate the user-specific map data as web graphics library (WebGL) data representing the event space and relevant booth spaces as three-dimensional objects, which may be sent to and interpreted by the user computing device 110 for presentation to the user via a user interface presented on the display 202.

At block 516, the event map management system 140 may cause the user-specific map to be presented to the user via the display 202 of the user computing device 110. This may include sending user-specific map data to the user computing device 110 via the communication network 130, such that an application running on the user computing device 110 receives the user-specific map data and presents a visual representation of the user-specific map to the user.

At block 518, the event map management system 140 may receive additional filters or filter criteria from the user computing device 110. Such additional filters or filter criteria may include limitations regarding additional aspects of the event space, such as the following: walkways, power outlets, lighting, setback requirements for booths in booth spaces, or height restrictions for booths in booth spaces. For example, the user may request a user-specific map showing a subset of user-available booth spaces that have meet a minimum height threshold in order to accommodate a booth design the user intends to install for the event. When the event map management system 140 receives an indication of additional filter criteria to apply to the event data, the event map management system 140 may add such additional filter criteria to the previously determined filter criteria and proceed to identify further user-filtered booth spaces for use in generating and presenting an additionally filtered map at blocks 510-516. The additionally filtered map may indicate the additionally filtered booth spaces by additional visually distinguishing characteristics, similar to or distinct from those included in the previously generated user-specific map. If no additional filters or filter criteria are received, the method 500 may continue with booth space reservations (block 520) or end.

At block 520, in some embodiments, the event map management system 140 may facilitate user reservation of a booth space by receiving a user selection of a booth space and reserving the booth space for the user by communication with the event registration system 150 via the communication network 130. In some such embodiments, user selection and booth space reservation may be implemented according to the exemplary booth space reservation method 700 described in further detail below.

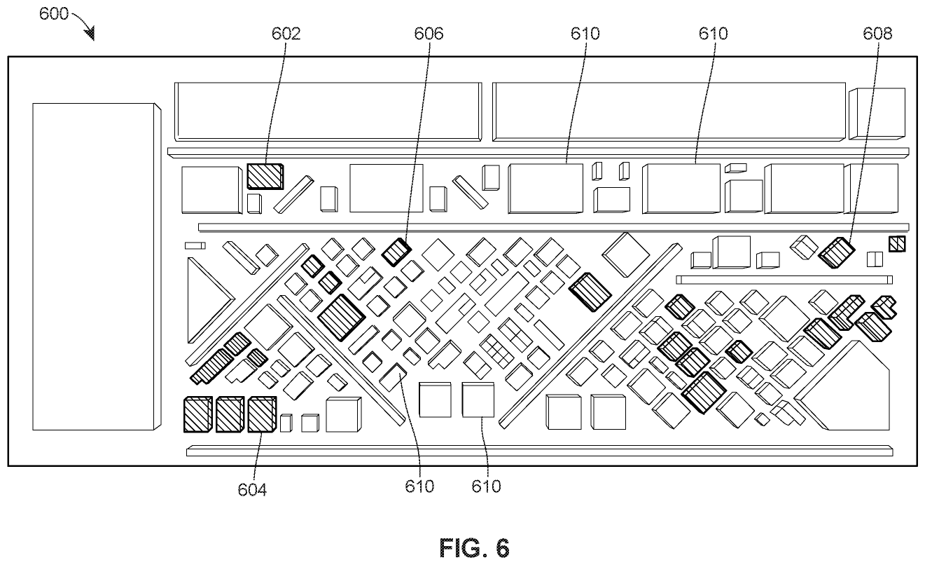

FIG. 6 illustrates an exemplary user-specific map 600 of the event space illustrated in event space map 400. Similar to the event space map 400, the user-specific map 600 shows the layout of booth spaces and other aspects of the event space, but the user-specific map 600 distinguishes between relevant booth spaces 602, 604, 606, and 608 (e.g., user-filtered booth spaces or user-available booth spaces) and unavailable booth spaces 610. As shown, the unavailable booth spaces 610 may be deemphasized, such as by being grayed out or increasing the transparency of such elements. Additionally, elements not related to booth spaces (e.g., walkways) may be likewise deemphasized. Alternatively, or additionally, the relevant booth spaces 602, 604, 606, and 608 may be emphasized, such as by applying a visually distinguishing characteristic to such elements within the user-specific map (e.g., by rending such booth space elements in a particular color). Thus, the user can easily identify the relevant booth spaces 602, 604, 606, and 608 within the event space in the user-specific map 600.

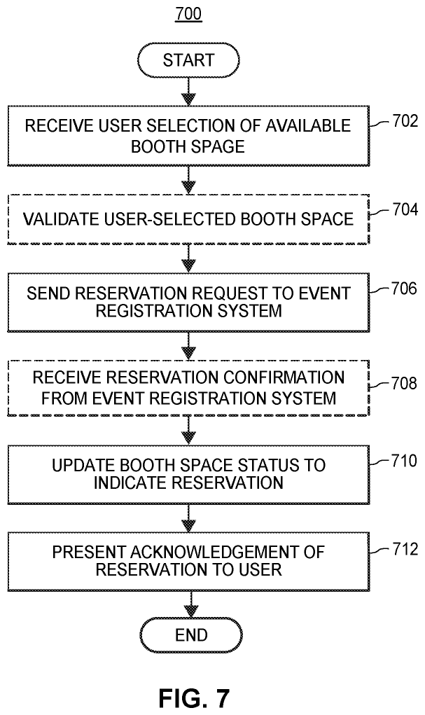

FIG. 7 illustrates a flow diagram of an exemplary booth space reservation method 700 for reserving an available booth space within an event space. The booth space reservation method 700 may be implemented in conjunction with the customized map generation method 500 discussed above to enable a user to select and reserve a booth space from a user-specific map of user-selectable booth spaces (e.g., user-filtered booth spaces or user-available booth spaces) in the event space at block 520. The booth space reservation method 700 may be implemented by the event map management system 140 in communication with the user computing device 110 and with the event registration system 150.

The booth space reservation method 700 may begin upon receiving a selection of an available booth space from a user-specific map (block 702). In some embodiments, the user-selected booth space may be validated to ensure availability (block 704). To reserve the booth space for the user, a reservation request is sent to the event registration system 150 (block 706), and a reservation confirmation may be received from the event registration system 150 (block 708) in some embodiments. The booth space status is then updated in the availability data stored in the event database 146 to indicate the reservation of the booth space (block 710), and an acknowledgement of the reservation is presented to the user (block 712).

At block 702, the event map management system 140 receives an indication of a selection by the user of a user-selected booth space from the user computing device 110. The user-selected booth space may be selected from one or more user-selectable booth spaces presented in a user-specific map of an event space, such as a user-filtered booth space or a user-available booth space. Upon a user selecting and requesting to reserve a user-selectable booth space, the user computing device may send a reservation request to the event map management system 140 via the communication network 130. The event map management system 140 receives the reservation request and determines the corresponding booth space.

At block 704, in some embodiments, the event map management system 140 may validate the user-selected booth space to ensure the booth space may be reserved by the user. Such validation may include confirming a match between the user attributes (e.g., a user booth type) and the booth type of the user-selected booth space. In some embodiments, validation may include determining the user-selected booth space is available to be reserved. Such availability check may be particularly useful in situations in which the user-specific map is not filtered using the availability data. In any event, the event map management system 140 may verify availability from the availability data associated stored in the event database 146 or by communication with the event registration system 150. When contacting the event registration system 150 to verify availability, the event map management system 140 may send an availability data request specifying the user-selected booth space and receive availability data associated with such booth space. In further embodiments, the event map management system 140 may request confirmation of the user attributes from the event registration system 150 in order to avoid errors at a further point in the reservation process, such as by confirming the user has the proper user booth type attribute for the user-selected booth space and that the user has not already reserved the user's maximum allotted number of booth spaces. If the user-selected booth space cannot be validated for reservation by the user for any reason, the event map management system 140 may return an error message and direct the user to select a different booth space.

At block 706, the event map management system 140 sends a reservation request to the event registration system 150 indicating the user's request to reserve the user-selected booth space. The reservation message includes an indication of the user-selected booth space to be reserved and an indication of the user reserving the booth space (e.g., a user ID). In some embodiments, the reservation message may further include additional details, instructions, questions, or requests regarding the reservation. For example, the user may indicate a need for an electrical power connection at the booth space, which may be included in the reservation message. The reservation request may be sent as an automated message to the event registration system 150 via the communication network 130. Such automated message may be a computer-readable message sent to an API of the event registration system 150, an automated e-mail message sent to an e-mail address associated with the event registration system 150, or another type of automated electronic message.

At block 708, in some embodiments, the event map management system 140 may receive a reservation confirmation from the event registration system 150 confirming the reservation has been accepted. Such confirmation message may be received shortly after the reservation request is sent, for example, when the event registration system 150 processes reservations on the basis of priority in time, either automatically or manually. Alternatively, the confirmation message may be received after a delay, such as when the reservations requests are manually reviewed by event organizers or other operators of the event registration system 150.

At block 710, the event map management system 140 updates the availability data associated with the user-selected booth space to indicate the reservation. Updating the availability data may include updating a status of the booth space in the event data stored in the event database 146, such as by changing the status from “available” to “reserved” or “reservation pending” to indicate the user-selected booth space is unavailable or potentially unavailable. The availability data may be updated without waiting for or requiring confirmation of the reservation from the event registration system 150. Thus, in some embodiments, an entry associated with the user-selected booth space may be updated in real time to indicate completed or pending reservation of the booth space by the user, thereby ensuring the event data remains current for other users. In some embodiments, the identity of the user may be associated with the user-selected booth space in the event data stored in the event database 146, such as by adding the user ID of the user to a record associated with the booth space, which may be used to identify the reservation status of the booth space.

At block 712, the event map management system 140 causes an acknowledgement of the reservation request to be presented to the user. Such acknowledgement may be presented to the user via the display 202 of the user computing device 110 in response to a message from the event map management system 140. Depending upon the handling of reservation requests, the reservation acknowledgement may indicate either confirmation of acceptance of the reservation or merely recognition of receipt of the reservation request. An appropriate message may accordingly be presented to the user.

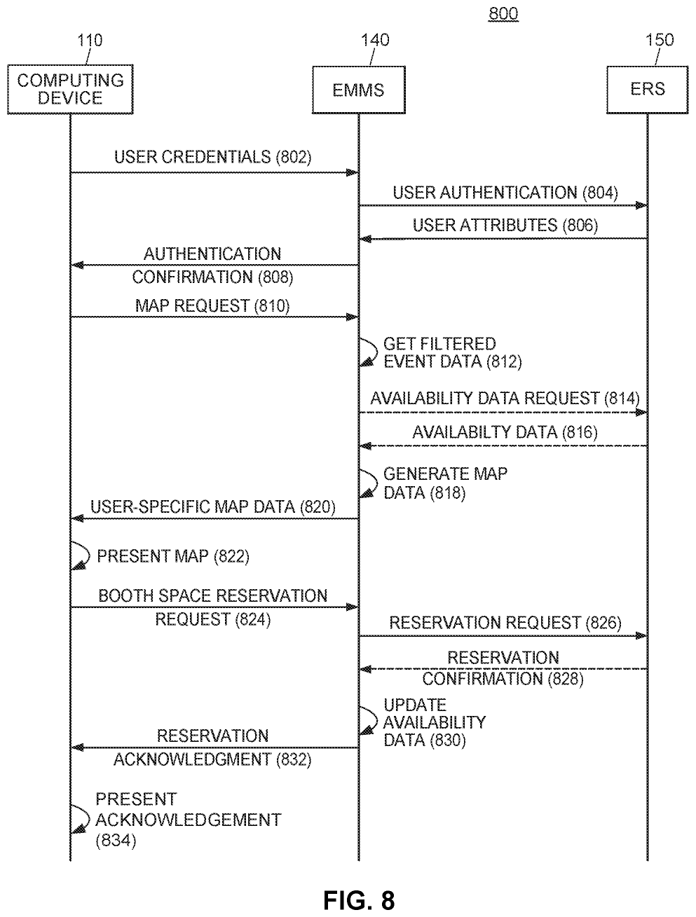

FIG. 8 illustrates a sequence diagram of an exemplary user-specific booth space identification and reservation communication sequence 800, such as by the customized map generation method 500 and the booth space reservation method 700 discussed above. The communication illustrated in the communication sequence 800 may occur via electronic messages exchanged over the communication network 130 between the user computing device 110, the event map management system 140, and the event registration system 150.

The communication sequence 800 may begin with transmission of user credentials from the user computing device 110 to the event map management system 140 in order to identify the user (line 802), such as by logging on or registering the user. Such user credentials may include a user ID and password, an authentication token previously associated with the user, or other identifying credentials. Upon receiving the user credentials, the event map management system 140 may authenticate the user by sending a user authentication message (line 804) to the event registration system 150 and receiving in response a message containing user attributes associated with the user (line 806). The event map management system 140 may send an authentication confirmation message (line 808) to the user computing device 110 to indicate successful identification and authentication of the user, indicating the establishment of a user session. Once the user session has been established, the user may request a user-specific map through a user interface of the user computing device 110. In response to such request, the user computing device 110 send a map request (line 810) to the event map management system 140. In response to such map request, the event map management system 140 may generate a user-specific map as described above. Generating the user-specific map may include getting user-filtered data from the event database 146 based upon the user attributes (line 812), which may include availability data. In some embodiments, the event map management system 140 may obtain or verify the availability data by sending an availability data request (814) to the event registration system 150 and receiving a response containing the availability data (816). After obtaining the necessary event data, the event map management system 140 may generate the user-specific map data (line 818) and send the user-specific map data to the user computing device 110 (line 820). Upon receiving the user-specific map data, the user computing device 110 may present a corresponding user-specific map to the user via the display 202 (line 822).

The user may then select a booth space from the user-specific map to reserve. In response to such selection, the user computing device 110 may send a booth space reservation request (line 824) to the event map management system 140, indicating the user-selected booth space to reserve. Upon receiving the booth space reservation request, the event map management system 140 may send a corresponding reservation request (line 826) indicating both the user and the user-selected booth space to the event registration system 150. In some embodiments, the event registration system 150 may respond to the event map management system 140 with a reservation confirmation (line 828). The event map management system 140 next updates the availability data in the event database 146 to indicate the reservation (or pending reservation) of the user-selected booth space (line 830) and sends a reservation acknowledgement (line 832) to the user computing device 110. The user computing device 110 may then present an acknowledgement of the reservation to the user via the display 202 (line 834).

### Other Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. For example, a module may comprise dedicated circuitry or logic that is permanently configured (e.g., as a special-purpose processor, such as a field programmable gate array (FPGA) or an application-specific integrated circuit (ASIC) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in dedicated and permanently configured circuitry, or in temporarily configured circuitry (e.g., configured by software) may be driven by cost and time considerations.

Accordingly, the term “module” should be understood to encompass a tangible entity, which entity may be physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time. In some embodiments, portions of the processor may be configured to constitute different modules at the same time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrases “in one embodiment” or “in some embodiments” in various places in the specification are not necessarily all referring to the same embodiment or embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for similar systems and methods using the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Although the foregoing text sets forth a detailed description of numerous different embodiments, it should be understood that the legal scope of the invention is defined by the words of the claims set forth at the end of this patent. The particular features, structures, or characteristics of any specific embodiment may be combined in any suitable manner and in any suitable combination with one or more other embodiments, including the use of selected features without corresponding use of other features. It is to be understood that other variations and modifications of the embodiments of the present invention described and illustrated herein are possible in light of the teachings herein and are to be considered part of the spirit and scope of the present invention. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘ ______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A computer-implemented method for providing dynamically customized mapping of event spaces, comprising:
receiving, at one or more processors, a request from a user to generate a user-specific map of an event space;
determining, by the one or more processors, one or more user attributes associated with the user, the one or more user attributes including a user booth type associated with the user from a plurality of booth types;
accessing, from an event database, event data associated with a plurality of booth spaces in the event space, the event data including (i) layout data regarding positions of the plurality of booth spaces within the event space and (ii) booth space data indicating a booth type of each booth space of the plurality of booth spaces from the plurality of booth types;
identifying, by the one or more processors, one or more user-filtered booth spaces from the plurality of booth spaces based upon a match between the user booth type and the booth type of the respective user-filtered booth space;
generating, by the one or more processors, a user-specific map of the event space using the layout data, the user-specific map indicating positions of each of the plurality of booth spaces and indicating the one or more user-filtered booth spaces by a visually distinguishing characteristic applied to each of the one or more user-filtered booth spaces; and
causing, by the one or more processors, the user-specific map to be presented to the user via a display of a user computing device.

2. The computer-implemented method of claim 1, wherein:
the event data further includes availability data indicating availability of each booth space of the plurality of booth spaces;
identifying the one or more user-filtered booth spaces further includes determining the one or more user-filtered booth spaces are available to be reserved by the user based upon the availability data; and
the one or more user-filtered booth spaces are one or more user-available booth spaces.

3. The computer-implemented method of claim 2, further comprising:
receiving, at the one or more processors, a selection of a user-selected booth space from the one or more user-available booth spaces;
reserving, by the one or more processors, the user-selected booth space by associating the user-selected booth space with the user; and
updating, by the one or more processors, the availability data to indicate the user-selected booth space as unavailable.

4. The computer-implemented method of claim 3, wherein reserving the user-selected booth space includes sending, via a communication network to an event registration system, a reservation message indicating reservation of the user-selected booth space by the user.

5. The computer-implemented method of claim 3, wherein the availability data is updated by updating an entry in the event database in real time upon receiving the selection of the user-selected booth space.

6. The computer-implemented method of claim 1, wherein determining one or more user attributes associated with the user includes:
sending, via a communication network to an event registration system, a user status request message including a user identifier uniquely identifying the user;
receiving, via the communication network from the event registration system, user registration data associated with the user, wherein the user registration data includes a registration level of the user; and
determining the one or more user attributes based upon the user registration data.

7. The computer-implemented method of claim 1, wherein the layout data further includes information regarding additional aspects of the event space, including one of more of the following: walkways, power outlets, lighting, setback requirements, or height restrictions.

8. The computer-implemented method of claim 7, further comprising:
receiving, by the one or more processors, an indication of additional filter criteria to apply to the plurality of booth spaces, wherein the additional filter criteria are associated with the additional aspects of the event space;
identifying, by the one or more processors, one or more additionally filtered booth spaces from the one or more user-filtered booth spaces based upon the additional filter criteria;
generating, by the one or more processors, an additionally filtered map of the event space using the layout data, the additionally filtered map indicating the one or more additionally filtered booth spaces by additional visually distinguishing characteristic applied to each of the one or more additionally filtered booth spaces; and
causing, by the one or more processors, the additionally filtered map to be presented to the user via the display of the user computing device.

9. The computer-implemented method of claim 1, wherein the user-specific map is a three-dimensional map representing the event space in three dimensions.

10. The computer-implemented method of claim 1, wherein the visually distinguishing characteristic includes one or more of the following: color, shading, or transparency.

11. A computer system for providing dynamically customized mapping of event spaces, comprising:
one or more processors;
a communication module adapted to communicate data via a communication network;
a program memory coupled to the one or more processors and storing executable instructions that, when executed by the one or more processors, cause the computer system to:
receive via the communication module a request from a user to generate a user-specific map of an event space;
determine one or more user attributes associated with the user, the one or more user attributes including a user booth type associated with the user from a plurality of booth types;
access event data associated with a plurality of booth spaces in the event space from an event database, the event data including (i) layout data regarding positions of the plurality of booth spaces within the event space and (ii) booth space data indicating a booth type of each booth space of the plurality of booth spaces from the plurality of booth types;
identify one or more user-filtered booth spaces from the plurality of booth spaces based upon a match between the user booth type and the booth type of the respective user-filtered booth space;
generate a user-specific map of the event space using the layout data, the user-specific map indicating positions of each of the plurality of booth spaces and indicating the one or more user-filtered booth spaces by a visually distinguishing characteristic applied to each of the one or more user-filtered booth spaces; and
cause the user-specific map to be presented to the user via a display of a user computing device by sending the user-specific map to the user device via the communication module.

12. The computer system of claim 11, wherein:
the event data further includes availability data indicating availability of each booth space of the plurality of booth spaces;
the executable instructions that cause the computer system to identify the one or more user-filtered booth spaces further cause the computer system to determine the one or more user-filtered booth spaces are available to be reserved by the user based upon the availability data; and
the one or more user-filtered booth spaces are one or more user-available booth spaces.

13. The computer system of claim 12, wherein the executable instructions further cause the computer system to:
receive via the communication module a selection of a user-selected booth space from the one or more user-available booth spaces;
reserve the user-selected booth space by associating the user-selected booth space with the user; and
update the availability data to indicate the user-selected booth space as unavailable.

14. The computer system of claim 13, wherein the executable instructions that cause the computer system to reserve the user-selected booth space further cause the computer system to send a reservation message indicating reservation of the user-selected booth space by the user to an event registration system via the communication module.

15. The computer system of claim 13, wherein:
the computer system further includes the event database; and
the executable instructions that cause the computer system to update the availability data further cause the computer system to update the availability data by updating an entry in the event database in real time upon receiving the selection of the user-selected booth space.

16. A tangible, non-transitory computer-readable medium storing executable instructions for providing dynamically customized mapping of event spaces that, when executed by one or more processors of a computer system, cause the computer system to:
receive a request from a user to generate a user-specific map of an event space;
determine one or more user attributes associated with the user, the one or more user attributes including a user booth type associated with the user from a plurality of booth types;
access event data associated with a plurality of booth spaces in the event space from an event database, the event data including (i) layout data regarding positions of the plurality of booth spaces within the event space and (ii) booth space data indicating a booth type of each booth space of the plurality of booth spaces from the plurality of booth types;
identify one or more user-filtered booth spaces from the plurality of booth spaces based upon a match between the user booth type and the booth type of the respective user-filtered booth space;
generate a user-specific map of the event space using the layout data, the user-specific map indicating positions of each of the plurality of booth spaces and indicating the one or more user-filtered booth spaces by a visually distinguishing characteristic applied to each of the one or more user-filtered booth spaces; and
cause the user-specific map to be presented to the user via a display of a user computing device.

17. The tangible, non-transitory computer-readable medium of claim 16, wherein:
the event data further includes availability data indicating availability of each booth space of the plurality of booth spaces;
the executable instructions that cause the computer system to identify the one or more user-filtered booth spaces further cause the computer system to determine the one or more user-filtered booth spaces are available to be reserved by the user based upon the availability data; and
the one or more user-filtered booth spaces are one or more user-available booth spaces.

18. The tangible, non-transitory computer-readable medium of claim 17, wherein the executable instructions further cause the computer system to:
receive a selection of a user-selected booth space from the one or more user-available booth spaces;
cause the user-selected booth space to be reserved by associating the user-selected booth space with the user; and
cause the availability data to be updated to indicate the user-selected booth space as unavailable.

19. The tangible, non-transitory computer-readable medium of claim 18, wherein the executable instructions that cause the user-selected booth space to be reserved further cause the computer system to send a reservation message indicating reservation of the user-selected booth space by the user to an event registration system.

20. The tangible, non-transitory computer-readable medium of claim 16, wherein the user-specific map is a three-dimensional map representing the event space in three dimensions.
